(19) United States
(12) Patent Application Publication
(10) Pub. No.: US 2024/0397255 A1
(43) Pub. Date: Nov. 28, 2024

(54) SPEAKER, SPEAKER BAFFLE, AND SPEAKER FRAME

(71) Applicant: Hosiden Corporation, Yao-shi (JP)

(72) Inventor: Satofumi Nagaoka, Yao-shi (JP)

(21) Appl. No.: 18/668,426

(22) Filed: May 20, 2024

(30) Foreign Application Priority Data
May 22, 2023 (JP) 2023-083818

(51) Int. Cl. H04R 1/28; H04R 1/02; H04R 7/18

(52) U.S. Cl. CPC H04R 1/2896; H04R 1/025; H04R 7/18; H04R 2201/029; H04R 2400/11

(57) ABSTRACT

A speaker includes a speaker unit having a diaphragm, an attachment member attached to an attachment object of the speaker unit, and an elastic body interposed between the speaker unit and the attachment member. The elastic body has a thin plate structure and connects the speaker unit and the attachment member at both ends of the elastic body in a state where a plate thickness direction is aligned with a vibration direction of the diaphragm.

### BACKGROUND OF THE INVENTION

### (1) Field of the Invention

The present invention relates to a speaker, a speaker baffle, and a speaker frame that can prevent vibration of a speaker unit from being transmitted to an attachment object.

### (2) Description of Related Art

The speaker produces sound by vibrations of the speaker unit, but they are transmitted to an attachment object (e.g., cabinet) to produce unnecessary sound. As a speaker for cutting them, a speaker in which an elastic body is interposed between the speaker unit and an attachment object to block vibration is known (see, for example, JP S62-139188 U).

### SUMMARY OF THE INVENTION

However, in the conventional speaker as described above, the elastic body applies a force in a compression direction with respect to the thickness, and therefore the elastic body needs to have a thickness in order to obtain a vibration-proof effect, which causes a space problem. Since the elastic body is interposed between the speaker unit and the attachment object, it is necessary to change the attachment method and the structure of the speaker unit from the conventional ones.

The present invention has been made in view of the problem as described above, and an object of the present invention is to provide a speaker, a speaker baffle, and a speaker frame that can obtain a sufficient vibration-proof effect in a space-saving manner and that do not require an attachment method and a structure of a speaker unit to be changed from conventional ones.

A speaker according to the present invention includes:
a speaker unit including a diaphragm;
an attachment member attached to an attachment object of the speaker unit; and
an elastic body interposed between the speaker unit and the attachment member,
in which the elastic body has a thin plate structure and connects the speaker unit and the attachment member at both ends of the elastic body in a state where a plate thickness direction is aligned with a vibration direction of the diaphragm.

A speaker baffle according to the present invention includes:
a baffle body covering a diaphragm of a speaker unit;
an attachment member attached to an attachment object of the speaker unit; and
an elastic body interposed between the baffle body and the attachment member,
in which the elastic body has a thin plate structure and connects the baffle body and the attachment member at both ends of the elastic body in a state where a plate thickness direction is aligned with a vibration direction of a diaphragm of the speaker unit.

A speaker frame according to the present invention includes:
a frame body holding a diaphragm of a speaker unit;
an attachment member attached to an attachment object of the speaker unit; and
an elastic body interposed between the frame body and the attachment member,
in which the elastic body has a thin plate structure and connects the frame body and the attachment member at both ends of the elastic body in a state where a plate thickness direction is aligned with a vibration direction of the diaphragm.

In the speaker, the speaker baffle, and the speaker frame according to the present invention, the attachment member may be configured by one component or may be divided into a plurality of components. Correspondingly, the elastic body may also be configured by one component or may be divided into a plurality of components.

According to the speaker, the speaker baffle, and the speaker frame according to the present invention, it is possible to provide a speaker, a speaker baffle, and a speaker frame that can obtain a sufficient vibration-proof effect in a space-saving manner and that do not require an attachment method and a structure to be changed from conventional ones.

### BRIEF DESCRIPTION OF THE DRAWINGS

FIG. 1 is an external perspective view illustrating a speaker according to a first embodiment of the present invention;

FIG. 2 is a cross-sectional view taken along line A-A of FIG. 1;

FIG. 3 is an external perspective view of an elastic body;

FIG. 4 is a cross-sectional view illustrating a speaker according to a second embodiment of the present invention; and

FIG. 5 is a cross-sectional view illustrating a deformation structure of an elastic body.

### DETAILED DESCRIPTION OF PREFERRED EMBODIMENTS

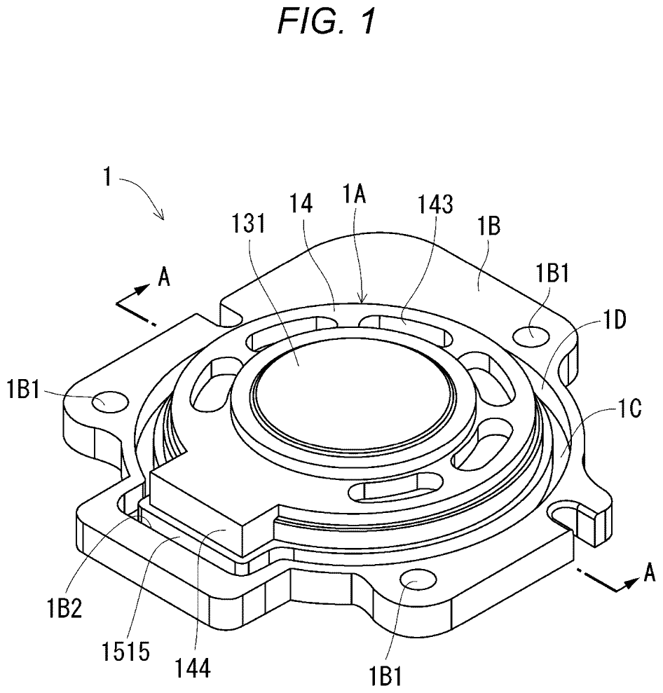

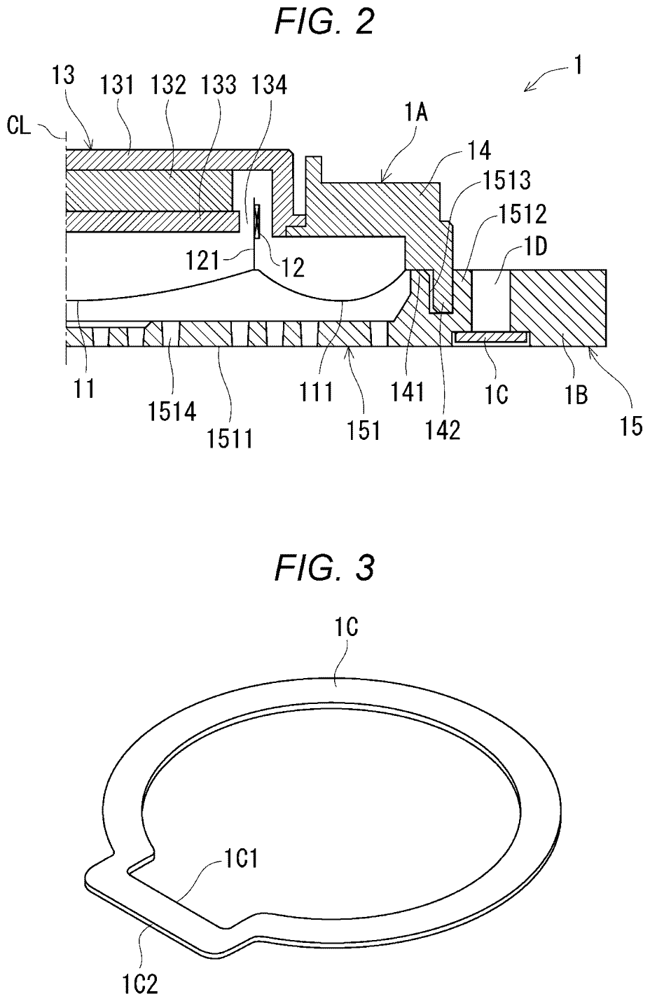

A speaker according to an embodiment of the present invention will be described below with reference to the drawings. FIG. 1 is an external perspective view of the speaker according to the embodiment of the present invention, FIG. 2 is a cross-sectional view taken along line A-A of FIG. 1, and FIG. 3 is an external perspective view of an elastic body 1C.

FIG. 1 illustrates an external appearance as viewed obliquely from above of a speaker unit 1A described later in a state where a back surface side faces upward. In FIGS. 1 and 2, the upper side of the drawing is the back surface side of the speaker unit 1A, and the lower side of the drawing is a front surface side of the speaker unit 1A.

A center line CL of the speaker unit 1A indicated by a dash-dot line in FIG. 2 is parallel to a vibration direction of a vibration system (a diaphragm 11 and a voice coil 12) described later of the speaker unit 1A, and passes through a center of the vibration system and a center of a drive system (a magnetic circuit 13) described later of the speaker unit 1A. The direction orthogonal to this center line CL is a radial direction R of the speaker unit 1A.

FIG. 2 illustrates the right half part from the center line CL of the cross-sectional view taken along line A-A of FIG. 1 and omits the left half part from the center line CL because it appears symmetrically with the right half part.

As illustrated in FIGS. 1 and 2, a speaker 1 includes the speaker unit 1A having the diaphragm 11, an attachment member 1B attached to an attachment object of the speaker unit 1A, and an elastic body 1C interposed between the speaker unit 1A and the attachment member 1B. The elastic body 1C has a thin plate structure and connects the speaker unit 1A and the attachment member 1B at both ends of the elastic body 1C in a state where a plate thickness direction is aligned with a vibration direction of the diaphragm 11. The attachment member 1B is connected to a speaker baffle 15 described later of the speaker unit 1A by the elastic body 1C.

The speaker unit 1A includes the diaphragm 11, the voice coil 12, the magnetic circuit 13, a speaker frame 14, and the speaker baffle 15.

The diaphragm 11 includes a thin film that does not allow air to pass, for example, a resin film or the like in order to push and vibrate the surrounding air by its own vibration to generate sound. In the diaphragm 11, an end part on a front surface side of the voice coil 12 having a tubular shape that vibrates the diaphragm 11 is concentrically and adhesively bonded to a back surface center part. The diaphragm 11 and the voice coil 12 constitute a vibration system of the speaker unit 1A. An edge portion 111 for connecting the diaphragm 11 to the speaker frame 14 is formed on an outer peripheral edge part of this diaphragm 11.

The diaphragm 11 has a dome shape. The shape of the diaphragm 11 is not limited to a dome shape, and may be, for example, a cone shape or the like. The edge portion 111 is of a roll type and has an arc-shaped cross-sectional shape. The edge portion 111 is an extension of the material of the diaphragm 11 (fixed edge), but may be formed of another material and bonded (free edge).

The voice coil 12 is wound along the outer peripheral surface of a bobbin 121 having a tubular shape and adhesively bonded to the diaphragm 11 via the bobbin 121.

The magnetic circuit 13 constitutes a drive unit of the speaker unit 1A. The magnetic circuit 13 includes a yoke 131 having a bottomed tubular shape made of a magnetic material, a magnet 132 having a columnar shape made of a permanent magnet disposed inside this yoke 131, and a pole piece 133 having a plate shape made of a magnetic material disposed on a front surface side of this magnet 132, and a magnetic gap 134 is formed between a peripheral side wall upper part of the yoke 131 and the pole piece 133.

The magnetic circuit 13 is of an inner magnetic type in which the magnet 132 is disposed inside the magnetic gap 134 (the voice coil 12). The configuration of the magnetic circuit 13 is not limited to the inner magnet type, and may be, for example, an outer magnet type in which a magnet is disposed outside a magnetic gap (voice coil).

The speaker frame 14 is made of a resin material and is formed integrally with the yoke 131 by insert molding. The speaker frame 14 is formed in a flange shape projecting outward in the radial direction R from a peripheral side wall of the yoke 131, and the magnetic circuit 13 is held at a center. In the speaker frame 14, an outer peripheral edge part 141 that is flat and a peripheral side wall 142 extending from the outer peripheral edge part of this outer peripheral edge part 141 to a front surface side are formed.

The material of the speaker frame 14 is not limited to a resin material, and may be, for example, a metal material. A bonding method of the speaker frame 14 and the yoke 131 may be adhesion. The speaker frame 14 may have any shape as long as it can hold the diaphragm 11 and the magnetic circuit 13 and is not limited to the shapes illustrated in FIGS. 1 and 2.

In the diaphragm 11, an outer peripheral edge part of the edge portion 111 is adhesively bonded to the outer peripheral edge part 141 of the speaker frame 14 and is held inside the peripheral side wall 142 of the speaker frame 14. The voice coil 12 is held in a state of being inserted into the magnetic gap 134 from the front surface side of the magnetic circuit 13.

The speaker baffle 15 includes a baffle body 151 fixed to the speaker frame 14, the attachment member 1B attached to an attachment object of the speaker unit 1A, and the elastic body 1C interposed between the baffle body 151 and the attachment member 1B. The elastic body 1C has a thin plate structure and connects the baffle body 151 and the attachment member 1B at both ends of the elastic body 1C in a state where a plate thickness direction is aligned with a vibration direction of the diaphragm 11 of the speaker unit 1A.

The baffle body 151 is a speaker baffle in which an attachment portion (flange in the present embodiment) attached to an attachment object of the speaker unit 1A is separated as a separate component from a speaker baffle integrally formed with attachment portion.

The baffle body 151 is made of a resin material, is formed in a bottomed tubular shape, and includes a top plate portion 1511 facing the diaphragm 11 and a peripheral side wall 1512 extending from an outer peripheral edge part of this top plate portion 1511 to a back surface side, and an end surface on the back surface side of this peripheral side wall 1512 is provided with a groove portion 1513 to which the peripheral side wall 142 of the speaker frame 14 is fitted.

The baffle body 151 is fixed to the front surface side of the speaker frame 14 in a state where the peripheral side wall 142 of the speaker frame 14 fitted in the groove portion 1513 and covers the diaphragm 11 from the front surface side. In fixing of the baffle body 151, the groove portion 1513 of the peripheral side wall 1512 and the peripheral side wall 142 are adhesively bonded to each other.

The top plate portion 1511 of the baffle body 151 present on the front surface side of the diaphragm 11 is provided with a sound hole 1514 for emitting sound to the front surface side of the speaker unit 1A, and the speaker frame 14 present on the back surface side of the diaphragm 11 is provided with a sound hole 143 for releasing air (sound) inside the speaker frame 14 shielded by the diaphragm 11 to the back surface side of the speaker unit 1A.

The attachment member 1B is an attachment portion (flange in the present embodiment) integrally formed with the speaker baffle and attached to an attachment object of the speaker unit 1A, and the attachment portion is separated as a separate component from the speaker baffle.

The attachment member 1B is made of a resin material and is formed in a frame shape so as to surround the peripheral side wall 1512 of the baffle body 151 in a state where a certain gap 1D is provided outside in the radial direction R of the peripheral side wall 1512 of the baffle body 151. This attachment member 1B is provided with a plurality of holes 1B1 having a diameter larger than a shaft part of a screw and a diameter smaller than a head part of the screw for screwing the speaker unit 1A to the attachment object. The attachment method and the attachment structure of the attachment member 1B to the attachment object of the speaker unit 1A are the same as those before the speaker unit 1A is separated as a separate component from the speaker baffle.

The elastic body 1C is made of an elastic material such as rubber or elastomer. The elastic body 1C has a thin plate structure in which the plate thickness direction is aligned with the vibration direction of the diaphragm 11. The elastic body 1C is formed in a frame shape along the gap 1D between the peripheral side wall 1512 of the baffle body 151 and the attachment member 1B (see FIG. 3). The elastic body 1C is disposed between the peripheral side wall 1512 of the baffle body 151 and the attachment member 1B so as to cover, from the front surface side, the gap 1D between the peripheral side wall 1512 of the baffle body 151 and the attachment member 1B. An inner end part of the elastic body 1C is connected to the front surface side outer peripheral edge part of the peripheral side wall 1512 of the baffle body 151. An outer end part of the elastic body 1C is connected to the front surface side inner peripheral edge part of the attachment member 1B.

The speaker baffle 15 can be manufactured by integrally forming the baffle body 151, the attachment member 1B, and the elastic body 1C by insert molding. Specifically, for example, the baffle body 151 and the attachment member 1B are injection-molded with the elastic body 1C as an insert component.

The speaker baffle 15 can be manufactured not only by the insert molding but also by, for example, integrally forming the baffle body 151, the attachment member 1B, and the elastic body 1C by two-color molding. Specifically, for example, the elastic body 1C is injection-molded as a primary molding, and the baffle body 151 and the attachment member 1B are injection-molded as a secondary molding.

In the speaker baffle 15, the baffle body 151, the attachment member 1B, and the elastic body 1C may be formed separately, and the speaker baffle 15 may be assembled by connecting the baffle body 151 and the elastic body 1C by adhesion and connecting the attachment member 1B and the elastic body 1C by adhesion. The baffle body 151 of the speaker baffle 15 and the attachment member 1B are not limited to the resin material, and may be, for example, a metal material.

While the outer shape of the diaphragm 11 and the outer shape of the magnetic circuit 13 of the speaker unit 1A are circular shapes, the speaker frame 14 has an outer shape in which one protrusion shape (protrusion portion) 144 is formed in a circular shape along the outer shape of the diaphragm 11 as illustrated in FIG. 1. Along with the outer shape of this speaker frame 14, the outer shape of the baffle body 151 has one protrusion shape (protrusion portion) 1515 in a circular shape along the outer shape of the speaker frame 14. Along with the outer shape of this baffle body 151, an inner shape (hole shape) of the attachment member 1B has one protrusion shape (protrusion portion) 1B2 in a circular shape along the outer shape of the baffle body 151. Furthermore, as illustrated in FIG. 3, along with the outer shape of the baffle body 151, an inner shape (hole shape) of the elastic body 1C has one inner protrusion shape 1C1 in a circular shape along the outer shape of the baffle body 151. Along with the inner shape of the attachment member 1B, the outer shape of the elastic body 1C has one outer protrusion shape 1C2 in a circular shape along the inner shape of the attachment member 1B.

Each of the protrusion shapes 144, 1515, 1B2, 1C1, and 1C2 illustrated in FIGS. 1 and 3 is a quadrangle, but each of the protrusion shapes 144, 1515, 1B2, 1C1, and 1C2 may have any shape as long as the entire circumference of the elastic body 1C becomes a uniform shape (circular shape) and is not limited to the shapes illustrated in FIGS. 1 and 3. Similarly to each of the protrusion shapes 144, 1515, 1B2, 1C1, and 1C2, the number of each of the protrusion shapes 144, 1515, 1B2, 1C1, and 1C2 is not limited to one and may be plural.

Next, functions and effects of the speaker 1 will be described. The speaker unit 1A is attached to, for example, an instrument panel of a vehicle by screwing a plurality of locations (holes 1B1) of the attachment member 1B. Sound data (electric signals) such as a blinker sound and a warning sound is supplied from a reproduction device mounted on the vehicle to the voice coil 12 of the speaker unit 1A, and sound such as the blinker sound and the warning sound is output by vibration of the voice coil 12 and the diaphragm 11.

The attachment method of the attachment member 1B to the attachment object of the speaker unit 1A is not limited to screwing and may be other methods such as bonding.

When the diaphragm 11 vibrates, the speaker unit 1A vibrates. The elastic body 1C interposed between the speaker unit 1A and the attachment member 1B is included, and the speaker unit 1A and the attachment member 1B are connected by the elastic body 1C. More specifically, the elastic body 1C is interposed between the baffle body 151 of the speaker unit 1A and the attachment member 1B, and the baffle body 151 of the speaker unit 1A and the attachment member 1B are connected by the elastic body 1C.

Due to this, the elastic body 1C can reduce a vibration transmission rate to the attachment member 1B even when the speaker unit 1A vibrates. That is, vibration transmitted from the speaker unit 1A to the attachment member 1B is damped, insulated, or blocked by the elastic body 1C. As a result, the speaker 1 can prevent vibration of the speaker unit 1A from being transmitted to the attachment object of the speaker unit 1A, that is, the instrument panel of the vehicle and can cut unnecessary sound.

As described above, the elastic body 1C is interposed between the speaker unit 1A and the attachment member 1B. More specifically, the elastic body 1C is interposed between the baffle body 151 of the speaker unit 1A and the attachment member 1B.

Due to this, the speaker 1 does not require the attachment method and the structure to change from the conventional ones. The attachment method and the structure can be changed from the conventional ones.

Furthermore, the elastic body 1C has a thin plate structure and connects the speaker unit 1A and the attachment member 1B at both ends of the elastic body 1C in a state where the plate thickness direction is aligned with the vibration direction of the diaphragm 11 of the speaker unit 1A. More specifically, the baffle body 151 of the speaker unit 1A and the attachment member 1B are connected.

Due to this, force is not applied in the compression direction with respect to the thickness of the elastic body 1C, but force is applied in a bending direction of the elastic body 1C, and the elastic body 1C can prevent the vibration transmission rate from the speaker unit 1A to the attachment member 1B to be small by not its own compression deformation but bending deformation. As a result, the speaker 1 can obtain a sufficient vibration-proof effect in a space-saving manner and can prevent vibration of the speaker unit 1A from being transmitted to the attachment object of the speaker unit 1A, that is, the instrument panel of the vehicle and can cut unnecessary sound.

In a case where the entire circumference of the elastic body 1C has a uniform shape and a circular shape, the elastic body 1C has one resonance point in a rolling mode (state where a twisting motion occurs due to a phenomenon of a non-uniform motion, so-called rolling, that occurs when the amplitude of the diaphragm 11 increases), and therefore vibration may be greatly amplified at a resonance frequency. The elastic body 1C has the inner shape in which one or more inner protrusion shapes 1C1 are provided to a circular shape, and the outer shape in which one or more outer protrusion shapes 1C2 are provided to a circular shape larger in diameter than the inner shape.

Due to this, the number of resonance points in the rolling mode is two or more, the number of resonance frequencies is plural, and the peak is simultaneously lowered. As a result, amplification of vibration is reduced, and a vibration damping effect is further exhibited.

The speaker 1 is used not only for blinker sound and warning sound of an in-vehicle instrument panel but also for various purposes such as vehicle industrial equipment and home electric machine and appliance. The attachment object of the speaker unit 1A is not limited to the in-vehicle instrument panel but may be any attachment objects of the speaker unit 1A in accordance with the intended use. Needless to say, the speaker unit 1A is also attached to a speaker cabinet via not the elastic body 1C but the attachment member 1B.

Although the speaker 1 includes the attachment member 1B including one component and the elastic body 1C including one component, the speaker 1 may include, for example, three of first, second, and third attachment members and three of first, second, and third elastic bodies. For example, each attachment member may be provided with one-hole 1B1 for screwing, and the attachment members may be connected to the speaker unit 1A, more specifically, the baffle body 151 of the speaker unit 1A by the respective elastic bodies.

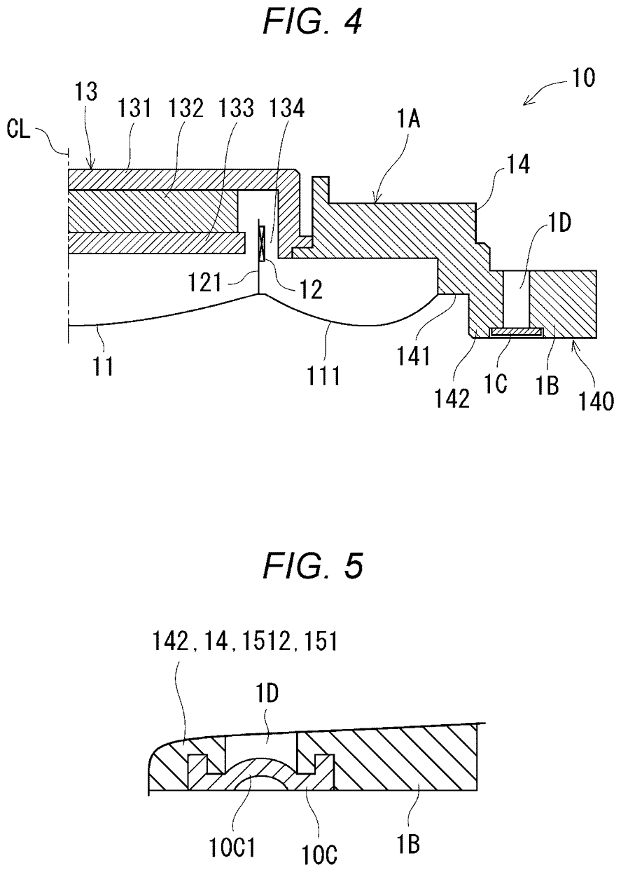

FIG. 4 is a cross-sectional view illustrating a speaker 10 according to the second embodiment of the present invention. FIG. 4 illustrates a cross section cut along the same cutting line as FIG. 3, also illustrates a right half part from the center line CL as in FIG. 3 and omits the left half part from the center line CL because it appears symmetrically with the right half part. In the speaker 10, the description similar to that of the first embodiment will be omitted.

The speaker 10 of the second embodiment is different from the speaker 1 of the first embodiment in that the attachment member 1B is connected to the speaker frame 14 of the speaker unit 1A by the elastic body 1C.

A speaker frame 140 includes the speaker frame 14 holding the diaphragm 11 of the speaker unit 1A, the attachment member 1B attached on an attachment object of the speaker unit 1A, and the elastic body 1C interposed between a frame body 14 and the attachment member 1B. The elastic body 1C has a thin plate structure and connects the frame body 14 and the attachment member 1B at both ends of the elastic body 1C in a state where a plate thickness direction is aligned with a vibration direction of the diaphragm 11.

The frame body 14 is a speaker frame in which the attachment portion attached to the attachment object of the speaker unit 1A is separated as a separate component from the speaker frame integrally formed with the attachment portion and is the speaker frame 14 of the speaker unit 1A described above.

The attachment member 1B is the attachment portion formed integrally with the speaker frame and attached to the attachment object of the speaker unit 1A. The attachment member is separated as a separate component from the speaker frame.

The attachment member 1B is formed in a frame shape so as to surround the peripheral side wall 142 of the frame body 14 in a state where the certain gap 1D is provided outside in the radial direction R of the peripheral side wall 142 of the frame body 14. The attachment method and the attachment structure of the attachment member 1B to the attachment object of the speaker unit 1A are the same as those before the speaker unit 1A is separated as a separate component from the speaker frame.

The elastic body 1C is formed in a frame shape along the gap 1D between the peripheral side wall 142 of the frame body 14 and the attachment member 1B. The elastic body 1C is disposed between the peripheral side wall 142 of the frame body 14 and the attachment member 1B so as to cover, from the front surface side, the gap 1D between the peripheral side wall 142 of the frame body 14 and the attachment member 1B. The inner end part of the elastic body 1C is connected to the front surface side outer peripheral edge part of the peripheral side wall 142 of the frame body 14. An outer end part of the elastic body 1C is connected to the front surface side inner peripheral edge part of the attachment member 1B.

The speaker frame 140 can be manufactured by integrally forming the frame body 14, the attachment member 1B, and the elastic body 1C by insert molding. Specifically, for example, the frame body 14 and the attachment member 1B are injection-molded with the elastic body 1C as an insert component. In this case, the yoke 131 can be adhesively bonded to the frame body 14. In the speaker frame 140, the frame body 14 and the attachment member 1B may be injection-molded using the elastic body 1C and the yoke 131 as insert components.

The speaker frame 140 can be manufactured not only by the insert molding but also by, for example, integrally forming the frame body 14, the attachment member 1B, and the elastic body 1C by two-color molding. Specifically, for example, the elastic body 1C is injection-molded as a primary molding, and the frame body 14 and the attachment member 1B are injection-molded as a secondary molding.

In the speaker frame 140, the frame body 14, the attachment member 1B, and the elastic body 1C may be formed separately, and the speaker frame 140 may be assembled by connecting the frame body 14 and the elastic body 1C by adhesion and connecting the attachment member 1B and the elastic body 1C by adhesion. The frame body 14 of the speaker frame 140 and the attachment member 1B are not limited to the resin material and may be, for example, a metal material.

While the outer shape of the diaphragm 11 and the outer shape of the magnetic circuit 13 of the speaker unit 1A are circular shapes, the frame body 14 has an outer shape in which one protrusion shape (protrusion portion) is formed in a circular shape along the outer shape of the diaphragm 11. Along with the outer shape of this frame body 14, the inner shape (hole shape) of the attachment member 1B has one protrusion shape (protrusion portion) in a circular shape along the outer shape of the frame body 14. Furthermore, as illustrated in FIG. 3, along with the outer shape of the frame body 14, the inner shape (hole shape) of the elastic body 1C has one inner protrusion shape 1C1 in a circular shape along the outer shape of the frame body 14. Along with the inner shape of the attachment member 1B, the outer shape of the elastic body 1C has one outer protrusion shape 1C2 in a circular shape along the inner shape of the attachment member 1B.

As described above, the speaker 10 of the second embodiment includes the elastic body 1C interposed between the speaker unit 1A and the attachment member 1B and connects the speaker unit 1A and the attachment member 1B by the elastic body 1C. More specifically, the elastic body 1C is interposed between the frame body 14 of the speaker unit 1A and the attachment member 1B, and the frame body 14 of the speaker unit 1A and the attachment member 1B are connected by the elastic body 1C.

The elastic body 1C has a thin plate structure and connects the speaker unit 1A and the attachment member 1B, more specifically, the frame body 14 of the speaker unit 1A and the attachment member 1B at both ends of the elastic body 1C in a state where the plate thickness direction is aligned with the vibration direction of the diaphragm 11 of the speaker unit 1A.

Furthermore, the elastic body 1C has the inner shape in which one or more inner protrusion shapes 1C1 are provided to a circular shape, and the outer shape in which one or more outer protrusion shapes 1C2 are provided to a circular shape larger in diameter than the inner shape.

Therefore, the speaker 10 of the second embodiment also has similar functions and effects to those of the speaker 1 of the first embodiment.

FIG. 5 is a cross-sectional view illustrating a deformation structure of the elastic body. In the description of an elastic body 10C illustrated in FIG. 5, the description similar to that of the elastic bodies 1C of the first embodiment and the second embodiment is omitted.

The elastic body 10C has a bent portion 10C1 bent in the plate thickness direction between an inner end part connected to the front surface side outer peripheral edge part of the peripheral side wall 1512 of the baffle body 151 or the front surface side outer peripheral edge part of the peripheral side wall 142 of the frame body 14 and an outer end part connected to the front surface side inner peripheral edge part of the attachment member 1B. The bent portion 10C1 has an arc-shaped cross-sectional shape similarly to the edge portion 111 having a roll shape of the diaphragm 11. The shape of the bent portion 10C1 is not limited to the roll shape and may be, for example, an S shape.

Such elastic body 10C has similar functions and effects to those of the elastic bodies 1C of the first embodiment and the second embodiment. In the elastic body 10C, since the length in the radial direction R is longer than that of the elastic body 1C, flexibility is increased more than that of the elastic body 1C. This can maintain linearity even when displacement increases and can exhibit the vibration-proof effect even in a state of being applied with vibration.

In the above-described embodiments, representative embodiments of the present invention are merely illustrated, the present invention is not limited to the above-described embodiments, and various modifications and additions can be made without departing from the gist of the present invention.

What is claimed is:

1. A speaker comprising:
a speaker unit including a diaphragm;
an attachment member attached to an attachment object of the speaker unit; and
an elastic body interposed between the speaker unit and the attachment member,
wherein the elastic body has a thin plate structure and connects the speaker unit and the attachment member at both ends of the elastic body in a state where a plate thickness direction is aligned with a vibration direction of the diaphragm.

2. The speaker according to claim 1, wherein the attachment member is connected to a speaker baffle or a speaker frame of the speaker unit.

3. The speaker according to claim 1, wherein the elastic body has a bent portion bent in a plate thickness direction.

4. The speaker according to claim 1, wherein the attachment member is connected to a speaker baffle or a speaker frame of the speaker unit by the elastic body, and the attachment member, the elastic body, and the speaker baffle or the speaker frame are integrally formed by insert molding.

5. The speaker according to claim 1, wherein the attachment member is connected to a speaker baffle or a speaker frame of the speaker unit by the elastic body, and the attachment member, the elastic body, and the speaker baffle or the speaker frame are integrally formed by two-color molding.

6. The speaker according to claim 1, wherein when an outer shape of the diaphragm is a circular shape, the elastic body has an inner shape in which one or more inner protrusion shapes are provided to a circular shape, and an outer shape in which one or more outer protrusion shapes are provided to a circular shape larger in diameter than the inner shape.

7. A speaker baffle comprising:
a baffle body having a sound hole and fixed to a speaker frame of a speaker unit;
an attachment member attached to an attachment object of the speaker unit; and
an elastic body interposed between the baffle body and the attachment member,
wherein the elastic body has a thin plate structure and connects the baffle body and the attachment member at both ends of the elastic body in a state where a plate thickness direction is aligned with a vibration direction of a diaphragm of the speaker unit.

8. A speaker frame comprising:
a frame body holding a diaphragm of a speaker unit;
an attachment member attached to an attachment object of the speaker unit; and
an elastic body interposed between the frame body and the attachment member,
wherein the elastic body has a thin plate structure and connects the frame body and the attachment member at both ends of the elastic body in a state where a plate thickness direction is aligned with a vibration direction of the diaphragm.
